(19) United States
(12) Patent Application Publication
(10) Pub. No.: US 2013/0319188 A1
(43) Pub. Date: Dec. 5, 2013

(54) TOOL HOLDER DEVICE

(71) Applicant: Wen Hung CHIANG, Taichung (TW)

(72) Inventor: Wen Hung CHIANG, Taichung (TW)

(21) Appl. No.: 13/484,580

(22) Filed: May 31, 2012

(51) Int. Cl. B25B 23/00

(52) U.S. Cl. 81/177.85

(57) ABSTRACT

A tool holder device includes a number of slots formed in a housing, a receptacle having two conduits perpendicular to each other, the housing has an end portion engaged into one of the conduits, a spindle is rotatably engaged in the housing, a shaft is rotatably engaged in the receptacle and has a bevel gear meshed with a bevel gear of the spindle, a barrel is attached onto the housing and has two ears, a handle has a cam member pivotally mounted to the ears of the barrel, the cam member is engageable with either of the slots of the housing for anchoring the handle and the barrel to the housing at selected angular positions when the handle is pivoted relative to the housing to the perpendicular working position.

### BACKGROUND OF THE INVENTION

1. Field of the Invention

The present invention relates to a tool holder device, and more particularly to a tool holder device including a structure for being solidly and stably held or supported by the users and for allowing the tool holder device to be suitably or effectively actuated or operated by the users, and including an elbow member for carrying or holding or supporting or retaining the tool members or tool elements at the predetermined or required position relative to the tool body, and for allowing the tool members or tool elements to be suitably or effectively actuated or operated by various kinds of driving tools.

2. Description of the Prior Art

Typical universal joints or tool extensions comprise two or more parts or elements or sections or couplings pivotally or rotatably connected or coupled together for connecting or coupling various kinds of different tool elements or fasteners to various kinds of driving tools.

For example, U.S. Pat. No. 7,018,298 to Chiou, U.S. Pat. No. 7,121,951 to Chang, U.S. Pat. No. 7,228,767 to Chang, U.S. Pat. No. 7,278,342 to Chang, U.S. Pat. No. 7,363,839 to Chiang, U.S. Pat. No. 7,392,727 to Chiang, and U.S. Pat. No. 7,481,136 to Chiang disclose several of the typical universal joints or tool extensions for various kinds of driving tool devices or the like each also comprising two or more pivotally coupled parts or elements or sections or coupling members for connecting or coupling various kinds of different driving tools to selectively engage with various kinds of different tool elements or fasteners and to drive or rotate the same.

However, the pivotally coupled parts or elements or sections or couplings may not be solidly and stably anchored or secured or retained in the predetermined or required position that the pivotally coupled parts or elements or sections or couplings are tilted or inclined relative to each other, and may not be used to solidly and stably engage with the other or different tool elements or fasteners such that the tool elements or fasteners may not be suitably or effectively rotated or driven by various kinds of driving tool devices, and the pivotally coupled parts or elements or sections or coupling members may not be solidly and stably held or supported by the users.

The present invention has arisen to mitigate and/or obviate the afore-described disadvantages of the conventional universal joints or tool extensions, tool coupling or connecting devices, or tool holder devices.

### SUMMARY OF THE INVENTION

The primary objective of the present invention is to provide a tool holder device including a structure for being solidly and stably held or supported by the users and for allowing the tool holder device to be suitably or effectively actuated or operated by the users, and including an elbow for carrying or holding or supporting or retaining the tool members or tool elements at the predetermined or required position relative to the tool body, and for allowing the tool members or tool elements to be suitably or effectively actuated or operated by various kinds of driving tools.

In accordance with one aspect of the invention, there is provided a tool holder device comprising a housing including a bore formed therein, and including a first end portion and a second end portion, and including a number of slots formed in a middle portion of the housing, a receptacle including a first conduit and a second conduit formed therein and perpendicular to each other and communicative with each other, the second end portion of the housing being engaged into the first conduit of the receptacle and secured to the receptacle, a spindle rotatably received and engaged in the bore of the housing, and including a first end portion extended out of the first end portion of the housing, and including a second end portion extended out of the second end portion of the housing and received in the first conduit of the receptacle, and including a first bevel gear provided on the second end portion the spindle, a shaft rotatably received and engaged in the second conduit of the receptacle, and including a second bevel gear provided thereon for engaging with the first bevel gear of the spindle and for allowing the shaft to be rotated relative to the receptacle by the spindle, the shaft including an engaging hole formed therein for selectively engaging with a tool member, a barrel rotatably attached onto the middle portion of the housing, and including a compartment formed therein for receiving the middle portion of the housing, and including a first ear and a second ear having a space formed between the first and the second ears, a handle including a cam member extended therefrom and engaged into the space of the barrel and pivotally mounted to the first and the second ears of the barrel with a pivot axle for allowing the handle to be pivoted relative to the housing and the barrel to a working position that is perpendicular to the housing, an intermediate folding position that is tilted relative to the housing, and a storing position that is parallel to the housing, the cam member being engageable with either of the slots of the housing for anchoring the handle and the barrel to the housing at a selected angular position when the handle is pivoted or rotated relative to the housing to the working position, and an anchoring device attached to the handle and engageable with the barrel for selectively anchoring and securing the handle to the housing and the barrel at the working position.

The barrel includes a depression formed in the second ear of the barrel, and the anchoring device includes a projection extended out of the handle for selectively engaging with the depression of the barrel and for anchoring the handle to the barrel and the housing at the working position.

The handle includes an orifice formed therein for slidably receiving and engaging with the anchoring device therein, and further includes a channel formed therein and communicative with the orifice of the handle for slidably receiving and engaging with the projection of the anchoring device, and for allowing the projection of the anchoring device to be moved or extended out of the handle.

The handle includes a spring biasing member engaged in the orifice of the handle and engaged with the anchoring device for biasing aid projection of the anchoring device to engage with the depression of the barrel.

The handle includes a retaining rod attached to the handle and engaged with the anchoring device for limiting the anchoring device to slide relative to the handle. The anchoring device includes a groove formed therein for slidably receiving and engaging with the retaining rod and for limiting the anchoring device to slide relative to the handle.

The barrel includes a second depression formed in the second ear of the barrel, and the projection of the anchoring device is selectively engageable with the second depression of the barrel for anchoring or retaining the handle to the barrel and the housing at a tilted folding position, or for anchoring the handle to the barrel and the housing at a storing position where the handle is parallel to the housing.

The handle includes a space formed therein for receiving a spare tool element. The barrel includes a number of recesses formed therein, and the housing includes a spring biased latch device attached thereto and engageable with either of the recesses of the barrel for anchoring the barrel to the housing at predetermined angular position.

The spring biased latch device includes a catch formed or provided thereon for selectively engaging with either of the recesses of the barrel. The shaft includes a detent slidably engaged in the shaft and engageable into the engaging hole of the shaft for selectively engaging with the tool member and for selectively securing or position or retaining the tool member to the shaft at the required position.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a tool holder device in accordance with the present invention;

FIG. 2 is a perspective view of the tool holder device;

FIG. 3 is a cross sectional view of the tool holder device taken along lines 3-3 of FIG. 2;

FIG. 4 is another cross sectional view similar to FIG. 3, illustrating the operation of the tool holder device;

FIG. 5 is a further cross sectional view of the tool holder device taken along lines 5-5 of FIG. 3;

FIG. 6 is a still further cross sectional view similar to FIG. 5, illustrating the operation of the tool holder device;

FIGS. 7, 8 are cross sectional views of the tool holder device taken along lines 7-7, and 8-8 of FIG. 4 respectively;

FIG. 9 is a still further cross sectional view similar to FIG. 8, illustrating the operation of the tool holder device;

FIG. 10 is a still further cross sectional view similar to FIGS. 1 and 4, illustrating the other arrangement of the tool holder device;

FIG. 11 is a still further cross sectional view taken along lines 11-11 of FIG. 10;

FIG. 12 is a still further cross sectional view similar to FIG. 11, illustrating the operation of the tool holder device as shown in FIGS. 10-11; and

FIG. 13 is a partial exploded view of the tool holder device as shown in FIGS. 10-12.

### DETAILED DESCRIPTION OF THE PREFERRED EMBODIMENT

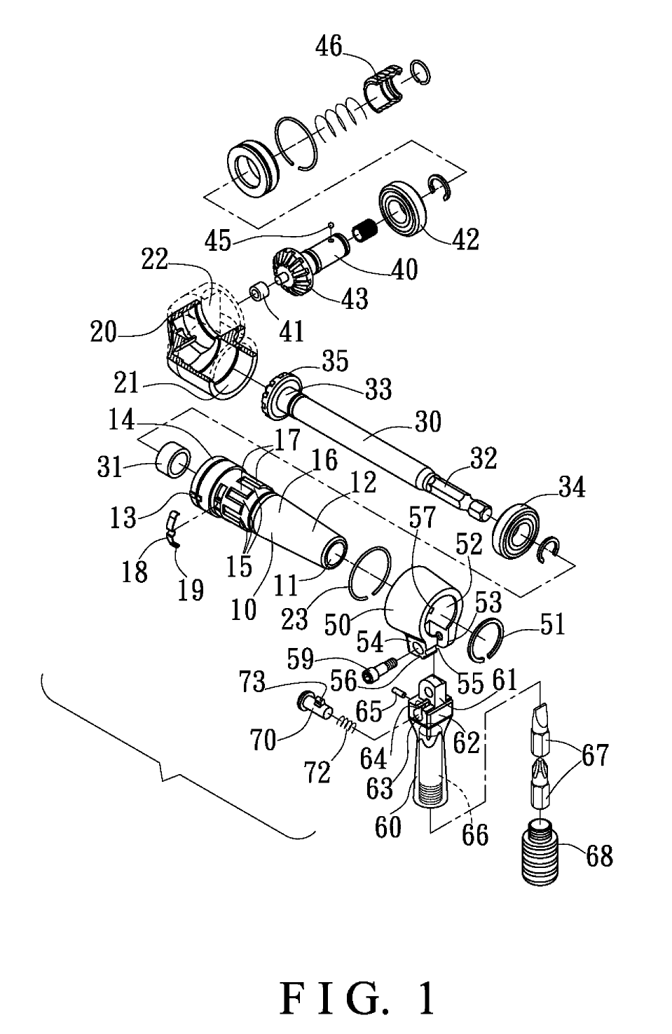

Referring to the drawings, and initially to FIGS. 1-5, a tool holder device 1 in accordance with the present invention comprises a receiving or carrying or holding or supporting member or housing 10 including a longitudinal bore 11 formed therein and formed through the length thereof, and including an outer or first end portion 12, and including one or more juts or projections or keys 13 extended radially and outwardly from the other or inner or second end portion 14 thereof, and including one or more grooves or channels or slots 15 formed in the middle portion 16 thereof and parallel to the longitudinal axis or direction of the housing 10 and faced or directed or opened toward the outer or first end portion 12 thereof for forming or defining one or more juts or projections or ribs 17, and including a spring blade or member or spring biased latch device 18 attached or mounted or secured onto the other or inner or second end portion 14 or the middle portion 16 thereof and having one or more juts or projections or catches 19 formed or provided thereon.

An elbow or receptacle 20 includes a C or L-shaped structure having two chambers or compartments or spaces or conduits 21, 22, such as a first conduit 21 and a second conduit 22 formed therein and substantially perpendicular to each other, and communicative with each other, the inner or second end portion 14 of the housing 10 is disposed or engaged into the first conduit 21 of the receptacle 20 and anchored or secured or retained to the receptacle 20 with a clamping or retaining ring 23, the keys 13 at the inner or second end portion 14 of the housing 10 are engaged with the receptacle 20 for anchoring or securing or positioning the inner or second end portion 14 of the housing 10 to the receptacle 20 and preventing the housing 10 from being pivoted or rotated relative to the receptacle 20, and relatively, also for preventing the receptacle 20 from being pivoted or rotated relative to the housing 10.

A stem or rod or spindle 30 is pivotally or rotatably received or engaged in the longitudinal bore 11 of the housing 10 with one or more bearing members or gaskets 31, and includes an outer or first end portion 32 extended out of the housing 10 and having a hexagonal cross section for selectively engaging with various kinds of driving tools (not shown) and for allowing the spindle 30 to be pivoted or rotated relative to the housing 10 with or by the driving tools (not shown), and includes an inner or second end portion 33 extended out of the inner or second end portion 14 of the housing 10 and pivotally or rotatably received or engaged in the first conduit 21 of the receptacle 20 with one or more gaskets or barrels or sleeves or bearing members 34 for allowing the spindle 30 to be smoothly pivoted or rotated relative to the receptacle 20 and the housing 10, and includes a bevel gear 35 formed or provided on the inner or second end portion 33 thereof and disposed or located close to the second conduit 22 of the receptacle 20.

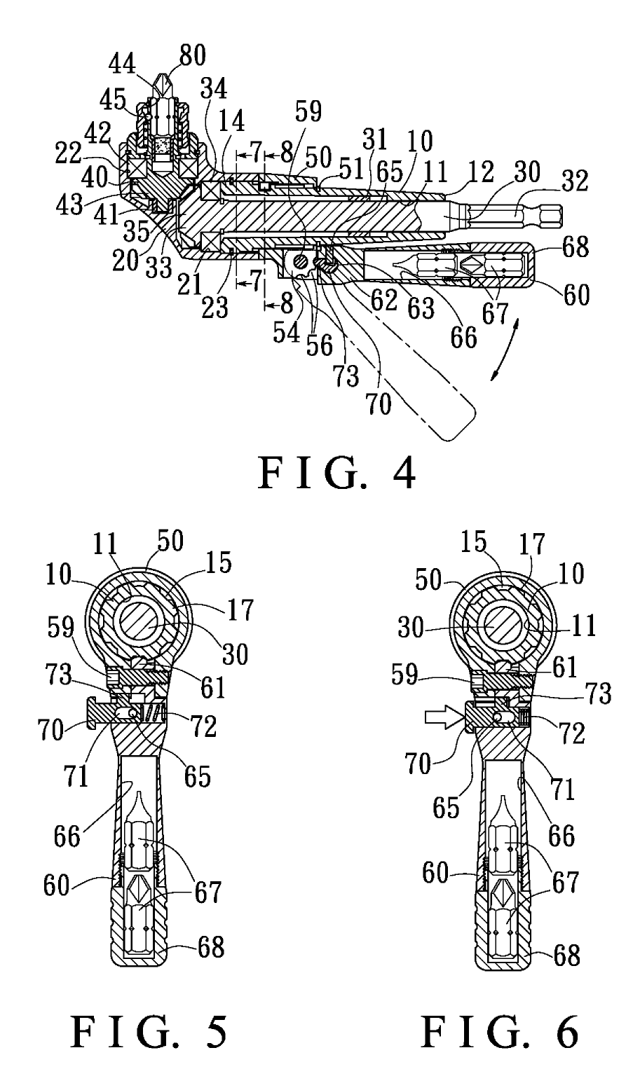

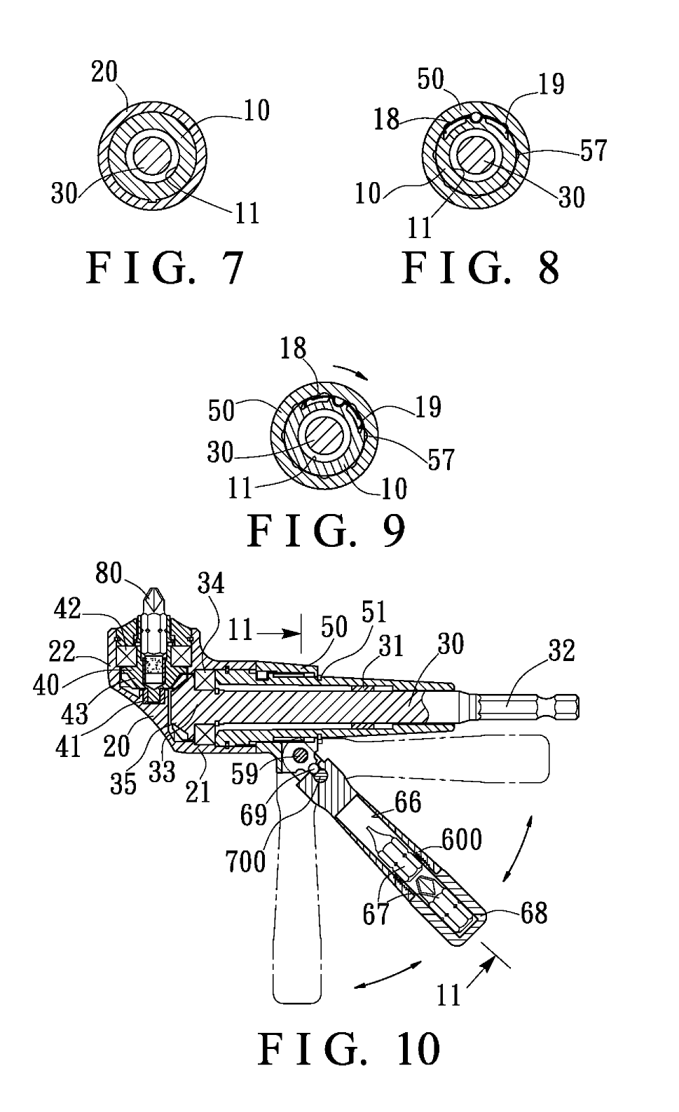

A stem or rod or shaft 40 is pivotally or rotatably received or engaged in the second conduit 22 of the receptacle 20 with one or more barrels or sleeves or gaskets 41 and/or one or more bearing members 42 for allowing the shaft 40 to be smoothly pivoted or rotated relative to the receptacle 20, and includes another bevel gear 43 formed or provided thereon for meshing or engaging with the bevel gear 35 of the spindle 30 and thus for allowing the shaft 40 to be pivoted or rotated relative to the receptacle 20 with or by the spindle 30. The shaft 40 includes a non-circular engaging hole 44 formed therein (FIGS. 3, 4) for selectively receiving or engaging with the various kinds of fasteners or tool elements or tool members 80. A detent 45 is slidably received or engaged in the shaft 40 and extendible or engageable into the engaging hole 44 of the shaft 40 for selectively engaging with the tool member 80 and for selectively anchoring or securing or retaining or locking the tool member 80 to the shaft 40.

A spring biased barrel or sleeve or control ferrule 46 is slidably attached or mounted or secured onto the shaft 40 and engageable with the detent 45 and for selectively actuating or operating or forcing the detent 45 to selectively engage with the tool member 80 and thus to selectively anchor or secure or retain or lock the tool member 80 to the shaft 40, and thus for allowing the tool member 80 and the shaft 40 to be selectively pivoted or rotated or driven by the spindle 30. The tool member 80 may be selectively disengaged or removed from the shaft 40 by sliding or moving the control ferrule 46 relative to the shaft 40 and to selectively disengage or release the detent 45 from the tool member 80. The tool member 80 may be selectively attached or mounted or anchored or secured or retained to the shaft 40 by the other or various kinds of lock sleeves or control ferrules which are typical and will not be described in further details.

A sleeve or barrel 50 is pivotally or rotatably attached or mounted or secured or engaged onto the middle portion 16 of the housing 10, and contacted or engaged with the first conduit 21 of the receptacle 20, and solidly and stably anchored or secured or retained to the receptacle 20 and/or the housing 10 with a clamping or retaining ring 51, and includes a space or chamber or compartment 52 formed therein for receiving or engaging with the middle portion 16 of the housing 10, and includes two flaps or ears 53, 54, such as a first ear 53 and a second ear 54 extended outwardly therefrom and parallel to each other for forming or defining a gap or space 55 between the ears 53, 54, and includes one or more (such as three) recesses or depressions 56 formed in the second ear 54 of the barrel 50, and includes a number of dents or cavities or recesses 57 (FIGS. 1 and 8-9) formed in the inner peripheral portion thereof for selectively engaging with the catches 19 of the spring blade or spring biased latch device 18 which may anchor or secure or position or retain the barrel 50 to the housing 10 at the predetermined or required angular position.

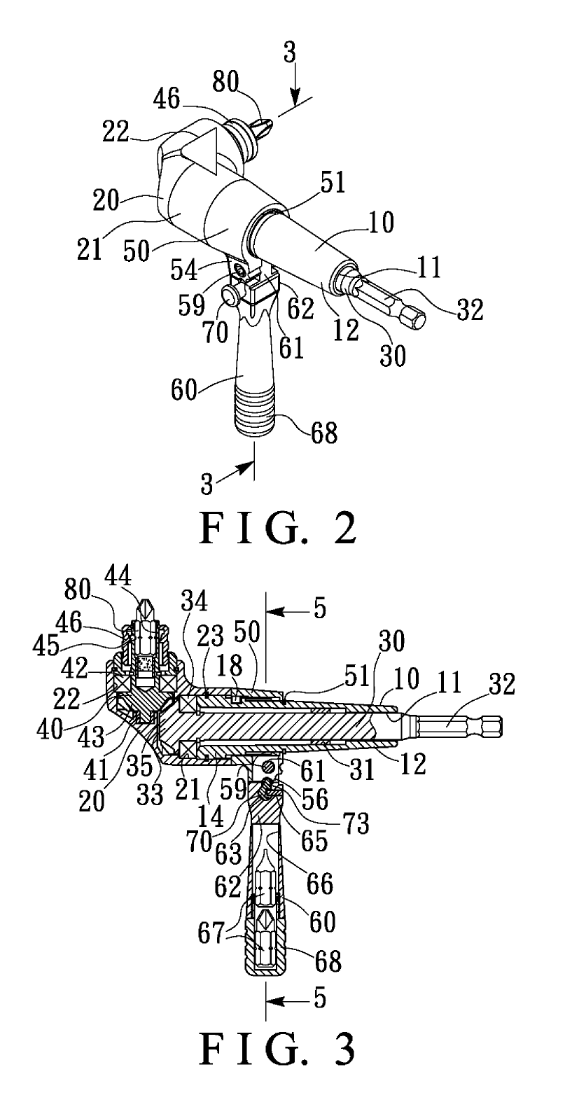

A handle 60 includes a cam member 61 extended upwardly from the upper portion 62 thereof and fitted or engaged into the space 55 that is formed between the ears 53, 54 of the barrel 50, and pivotally or rotatably attached or mounted or secured or coupled to the ears 53, 54 of the barrel 50 with a pivot axle 59 for allowing the cam member 61 and the handle 60 to be pivoted or rotated relative to the housing 10 to different angular position, such as a working position that is perpendicular to the housing 10 (FIGS. 2, 3), an intermediate folding position that is tilted or inclined relative to the housing 10, as shown in dotted lines in FIG. 4, or a folding or receiving or storing position that is substantially parallel to the housing 10, as shown in solid lines in FIG. 4. The cam member 61 of the handle 60 is engageable with either of the slots 15 of the housing 10 for anchoring or securing or retaining the handle 60 and the barrel 50 to the housing 10 at the predetermined or required angular position.

For example, as shown in FIGS. 2 and 3, when the handle 60 is pivoted or rotated relative to the housing 10 to the working position that is perpendicular to the housing 10, the cam member 61 of the handle 60 may be selectively engaged with either of the slots 15 of the housing 10 in order to solidly and stably anchor or secure or position or retain the handle 60 and the barrel 50 to the housing 10 at the predetermined or required angular position. As shown in solid lines in FIG. 4, when the handle 60 is pivoted or rotated relative to the housing 10 to the folding or receiving or storing position that is substantially parallel to the housing 10, for example, the cam member 61 of the handle 60 may be removed or released or disengaged from the slots 15 and the ribs 17 of the housing 10 for allowing the housing 10 to be pivoted or rotated relative to the handle 60 and the barrel 50 to the other or different angular position before the cam member 61 of the handle 60 is engaged with either of the slots 15 of the housing 10 again, and/or when the handle 60 is not pivoted or rotated relative to the housing 10 to the working position.

The handle 60 includes an orifice 63 laterally formed therein for slidably receiving or engaging with a detent or shank or anchoring device 70 therein, and includes a channel 64 formed therein (FIG. 1) and communicative with the orifice 63 of the handle 60, and includes an anchoring or securing or locking or retaining stem or rod 65 attached or mounted or secured to the handle 60 and extended or engaged into the orifice 63 of the handle 60 (FIGS. 3, 4). The anchoring device 70 includes a channel or groove 71 formed therein (FIGS. 5 and 6) for slidably receiving or engaging with the anchoring or securing or retaining or locking stem or rod 65 and for limiting the anchoring device 70 to slide relative to the handle 60, and for preventing the anchoring device 70 from being removed or released or disengaged from the handle 60 inadvertently, and includes a spring biasing member 72 also received or engaged in the orifice 63 of the handle 60 and contacted or engaged with the anchoring device 70 for biasing or moving the anchoring device 70 out of the orifice 63 of the handle 60.

The anchoring device 70 further includes a nib or jut or catch or projection 73 extended outwardly therefrom and slidably received or engaged in the channel 64 of the handle 60, and extended out of the handle 60 for selectively engaging with either of the depressions 56 of the barrel 50, and for selectively anchoring or securing or retaining the handle 60 to the barrel 50 and the housing 10 at the predetermined or required angular position. The spring biasing member 72 may bias or move or force the projection 73 of the anchoring device 70 to engage with either of the depressions 56 of the barrel 50 in order to anchor or secure or retain the handle 60 to the barrel 50 and the housing 10 at the predetermined or required or selected angular position, such as the working position that is perpendicular to the housing 10 (FIGS. 2, 3), the intermediate folding position that is tilted or inclined relative to the housing 10, as shown in dotted lines in FIG. 4, or the storing position that is substantially parallel to the housing 10, as shown in solid lines in FIG. 4.

The projection 73 of the anchoring device 70 may be selectively disengaged or removed from the depressions 56 of the ear 54 of the barrel 50 when the anchoring device 70 is depressed or moved into the orifice 63 of the handle 60 and onto the spring biasing member 72 (FIG. 6) by the user, and the projection 73 of the anchoring device 70 may then be biased or forced or moved to selectively engage with either of the depressions 56 of the barrel 50 again by the spring biasing member 72 when the user releases the anchoring device 70. The handle 60 may further include a chamber or compartment or space 66 formed therein for receiving or engaging with the other or the spare tool elements or tool members 67, and a cap or cover 68 attached or mounted or secured to the handle 60 for suitably and stably anchoring or securing or retaining the spare tool elements or tool members 67 in the space 66 of the handle 60.

In operation, as shown in FIGS. 2 and 3, the tool member 80 may be solidly and stably held or supported by the user with the shaft 40 and the receptacle 20 and the housing 10 and the handle 60, and may be forcefully engaged onto the work piece (not shown), and the hexagonal outer or first end portion 32 of the spindle 30 may be selectively engaged with various kinds of driving tools (not shown) and for allowing the spindle 30 to be suitably and effectively pivoted or rotated or driven relative to housing 10 with the driving tools (not shown). The projection 73 of the anchoring device 70 may be used to selectively engage with either of the depressions 56 of the barrel 50 for selectively anchoring or securing or retaining the handle 60 to the barrel 50 and the housing 10 at the predetermined or required angular position, particularly at the working position. The cam member 61 of the handle 60 may be engaged with either of the slots 15 of the housing 10 for anchoring or securing or retaining the housing 10 to the handle 60 and the barrel 50 at the predetermined or required angular position.

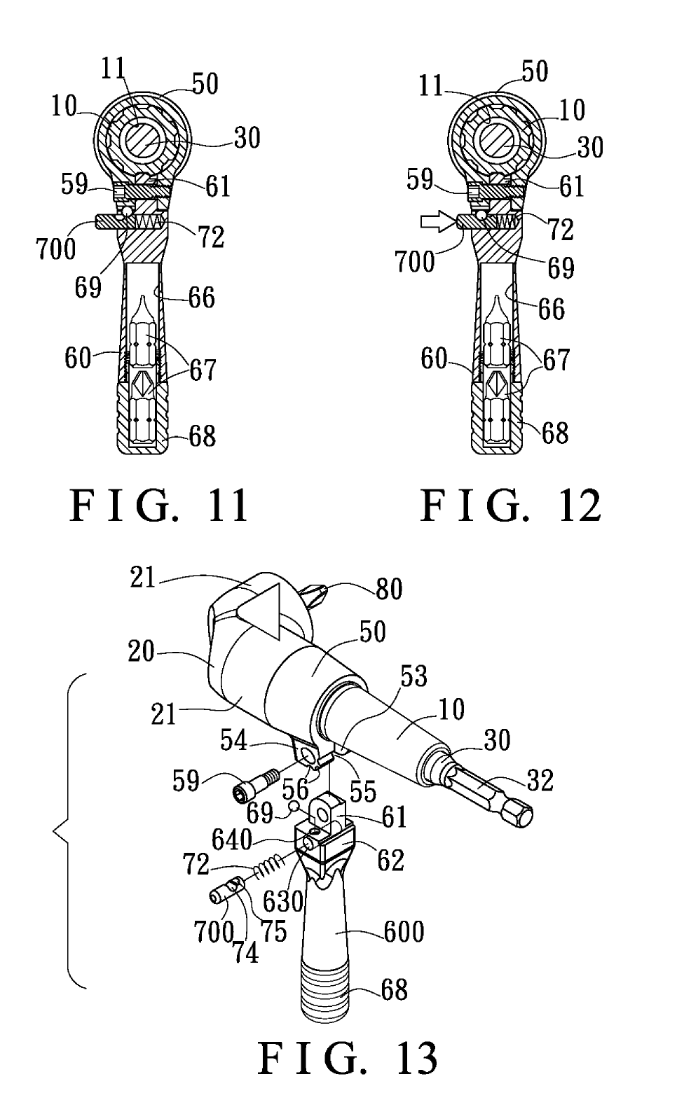

Alternatively, as shown in FIGS. 10-13, the handle 600 may include an orifice 630 laterally formed therein for slidably receiving or engaging with an anchoring device 700 therein, and may include an aperture 640 formed therein and communicative with the orifice 630 of the handle 600 for slidably receiving or engaging with a projection or detent 69 which is extended or engaged into the orifice 630 of the handle 600. The anchoring device 700 includes a lower or deeper recess 74 formed therein for selectively receiving or engaging with the detent 69 and for allowing the detent 69 to be selectively disengaged or removed from the depressions 56 of the ear 54 of the barrel 50 and for allowing the handle 600 to be selectively pivoted or rotated relative to the housing 10 and the barrel 50 to different angular position.

The anchoring device 700 further includes a shallower recess or a table or platform 75 formed or provided thereon for selectively receiving or engaging with the detent 69 and for selectively actuating or operating or forcing the detent 69 to selectively engage with either of the depressions 56 of the barrel 50, and thus to selectively anchor or position or secure or retain the handle 600 to the barrel 50 and the housing 10 at the predetermined or required angular position. The housing 10 may only be pivoted or rotated relative to the barrel 50 when the handle 600 is pivoted or rotated relative to the housing 10 to the folding or storing position that is parallel to the housing 10, and may not be pivoted or rotated relative to the barrel 50 when the handle 600 is not pivoted or rotated toward the housing 10.

Accordingly, the tool holder device in accordance with the present invention includes an improved configuration or structure for being solidly and stably held or grasped or supported by the users and for allowing the tool holder device to be suitably or effectively actuated or operated by the users, and including an elbow for carrying or holding or supporting or retaining the tool members or tool elements at the predetermined or required position relative to the tool body, and for allowing the tool members or tool elements to be suitably or effectively actuated or operated by various kinds of driving tools.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tool holder device comprising:
a housing including a bore formed therein, and including a first end portion and a second end portion, and including a plurality of slots formed in a middle portion of said housing,
a receptacle including a first conduit and a second conduit formed therein and perpendicular to each other and communicative with each other, said second end portion of said housing being engaged into said first conduit of said receptacle and secured to said receptacle,
a spindle rotatably received and engaged in said bore of said housing, and including a first end portion extended out of said first end portion of said housing, and including a second end portion extended out of said second end portion of said housing and received in said first conduit of said receptacle, and including a first bevel gear provided on said second end portion said spindle,
a shaft rotatably received and engaged in said second conduit of said receptacle, and including a second bevel gear provided thereon for engaging with said first bevel gear of said spindle and for allowing said shaft to be rotated relative to said receptacle by said spindle, said shaft including an engaging hole formed therein for selectively engaging with a tool member,
a barrel rotatably attached onto said middle portion of said housing, and including a compartment formed therein for receiving said middle portion of said housing, and including a first ear and a second ear having a space formed between said first and said second ears,
a handle including a cam member extended therefrom and engaged into said space of said barrel and pivotally mounted to said first and said second ears of said barrel with a pivot axle for allowing said handle to be pivoted relative to said housing and said barrel to a working position that is perpendicular to said housing, an intermediate folding position that is tilted relative to said housing, and a storing position that is parallel to said housing, said cam member being engageable with either of said slots of said housing for anchoring said handle and said barrel to said housing at a selected angular position when said handle is pivoted relative to said housing to the working position, and
an anchoring device attached to said handle and engageable with said barrel for selectively anchoring and securing said handle to said housing and said barrel at the working position.

2. The tool holder device as claimed in claim 1, wherein said barrel includes a depression formed in said second ear of said barrel, and said anchoring device includes a projection extended out of said handle for selectively engaging with said depression of said barrel and for anchoring said handle to said barrel and said housing at the working position.

3. The tool holder device as claimed in claim 2, wherein said handle includes an orifice formed therein for slidably receiving and engaging with said anchoring device therein, and includes a channel formed therein and communicative with said orifice of said handle for slidably receiving and engaging with said projection of said anchoring device, and for allowing said projection of said anchoring device to be extended out of said handle.

4. The tool holder device as claimed in claim 3, wherein said handle includes a spring biasing member engaged in said orifice of said handle and engaged with said anchoring device for biasing aid projection of said anchoring device to engage with said depression of said barrel.

5. The tool holder device as claimed in claim 2, wherein said handle includes a retaining rod attached to said handle and engaged with said anchoring device for limiting said anchoring device to slide relative to said handle.

6. The tool holder device as claimed in claim 5, wherein said anchoring device includes a groove formed therein for slidably receiving and engaging with said retaining rod and for limiting said anchoring device to slide relative to said handle.

7. The tool holder device as claimed in claim 2, wherein said barrel includes a second depression formed in said second ear of said barrel, and said projection of said anchoring device is selectively engageable with said second depression of said barrel for anchoring said handle to said barrel and said housing at a tilted folding position.

8. The tool holder device as claimed in claim 2, wherein said barrel includes a second depression formed in said second ear of said barrel, and said projection of said anchoring device is selectively engageable with said second depression of said barrel for anchoring said handle to said barrel and said housing at a storing position where said handle is parallel to said housing.

9. The tool holder device as claimed in claim 1, wherein said handle includes a space formed therein for receiving a spare tool element.

10. The tool holder device as claimed in claim 1, wherein said barrel includes a plurality of recesses formed therein, and said housing includes a spring biased latch device attached thereto and engageable with either of said recesses of said barrel for anchoring said barrel to said housing at predetermined angular position.

11. The tool holder device as claimed in claim 10, wherein said spring biased latch device includes a catch provided thereon for selectively engaging with either of said recesses of said barrel.

12. The tool holder device as claimed in claim 1, wherein said shaft includes a detent slidably engaged in said shaft and engageable into said engaging hole of said shaft for selectively engaging with the tool member and for selectively retaining the tool member to said shaft.
